(19) United States
(12) Patent Application Publication
(10) Pub. No.: US 2005/0199609 A1
(43) Pub. Date: Sep. 15, 2005

(54) Soft heating device

(76) Inventors: Reinhold Wanner, Hochstadt (DE); Hans-georg Gingl, Blaubeuren (DE); Ernst Merk, Weissenhorn (DE); Ralf Kohler, Langenau (DE); Ingolf Rathgeb, Risstissen (DE); Werner Bader, Giengen (DE)

Correspondence Address: PAULEY PETERSEN & ERICKSON, 2800 WEST HIGGINS ROAD, SUITE 365, HOFFMAN ESTATES, IL, 60195, US

(21) Appl. No.: 10/523,099

(22) PCT Filed: Jan. 10, 2004
(86) PCT No.: PCT/EP04/00122

§ 371 Date: Feb. 1, 2005

(30) Foreign Application Priority Data
Jan. 23, 2003 (EP) 03001466.6
Feb. 28, 2003 (DE) 10308724.9

(51) Int. Cl. H05B 3/02

(52) U.S. Cl. 219/528; 219/507; 219/217; 219/541

(57) ABSTRACT

A soft heating device such as a heat blanket, heat cushion or heat feather-bed, having at least one heating cord arranged on a base heating element, a connection cable for an energy supply connected by an externally insulated connecting means, and a control circuit. The heating device has a robust structure because the connecting means are grouped together in a connecting unit comprising a common carrier plate and/or a common encapsulating element.

### BACKGROUND OF THE INVENTION

1. Field of the Invention

This invention relates to a supple heating device, such as a heating blanket, heating pad or heated mattress pad, having at least one heater cord arranged on a base heating element, a connecting cable for energy supply connected by a connecting device insulated toward the outside, and a control circuit.

2. Discussion of Related Art

A heating device is disclosed, for example, by German Patent Reference DE 101 26 066 A1, in which a connection between a heater cord and a connecting cable is shown in edge areas of a base heating element, for example a blanket. Besides the heater cord with the heating wires contained therein, further structural components of the electrical circuit can be arranged, such as in the edge areas of the blanket, such as with a fuse and an indicator element, for example with wiring. It is possible to provide a rectifier arrangement between the ends of the two heating wires of the heater cord which are remote from the connecting cable. A control circuit has at least one on/off switch, with even a multi-stage switch, and can comprise further components.

A heating device is taught by European Patent Reference EP 0 562 850 A2, wherein the heater cord, which also has two coaxial heating wires, for example, is connected via two connecting terminals with a connecting cable, over whose length a control circuit is arranged. The control circuit has a special safety system, which has a rectifier device in the form of a diode arranged between the heating wires at the end of the heater cord remote from the connecting end, a fuse in the control circuit, which can be thermally triggered. During normal operations, the diode which is arranged in series between the heating wires lets only a half-wave of the supply current through, but if a short circuit occurs in the heating wires the negative half-wave of the heating current is let through and is then conducted via a further rectifier arrangement in the control circuit of a resistor arrangement, which is thermally coupled with a fuse responsive to a temperature increase and triggers the fuse in case of a short circuit in the heating wires. The control circuit also comprises a control member in the form of a thyristor for temperature regulation.

With heating devices of this type dependable assembly and functioning are of particular importance.

### SUMMARY OF THE INVENTION

One object of this invention is to provide a supple heating device of the type mentioned above but in which a dependable assembly and functioning are achieved, or at least furthered.

This object is achieved with a connecting device combined into a connecting unit which has a common support plate and/or a common encapsulating element.

Thus there is increased dependability because of the simple clear design of critical connecting points.

Here, the connecting unit can be arranged on the base heating element and is fixed in place by a holding device.

Definite mounting characteristics are achieved if the support plate is designed as a board with printed strip conductors, and the supporting plate supports several connecting elements of the connecting device, some of which are connected with an associated heating conductor and some which are connected with an associated lead of the connecting cable and to the extent provided are connected with each other by strip conductors for creating respective current paths.

If the heater cord has two heating conductors, which are connected at the one cord end with associated leads of the connecting cable and at the other cord end are electrically connected with each other directly or via a rectifier arrangement contained in the connecting unit, both cord ends can be simply connected and wired.

A structure which is advantageous for mounting and functioning is achieved because a current safety fuse included in the connecting unit is arranged in the supply current circuit.

The steps wherein the encapsulation element is provided by encasing or by two assembled shell elements contribute further to safety. In this case the insulating material is matched to the particular safety requirements in regard to a cast or injection-molded encapsulating element and in regard to one embodiment as a shell wherein, because of the increased contact resistance, the insulating properties and steps in connection with plug or clamped or crimped connections are matched to higher requirements than soldered connections, for example.

With a simple construction, critical points in the heating cord and the connecting cable are dependably protected because the encapsulating element has at least one cord guidance device formed thereon for the heater cords, and a cable guidance device for the formed on connecting cable.

Further advantageous measures which contribute to safety include the encapsulating element made of an elastic plastic material, at least in the area of each cord guidance device and/or of the cable guidance device, and is melt-resistant to at least 150° C., as well as flame-resistant and resistant to tensile strain.

Those steps contribute to simple mounting and the provision of a dependable contact, wherein the connecting device is designed for inserting and clamping one or both heater cord ends in place with electrical contact, and wherein, on its side facing the connecting device, a cover element has formed-out places, which work together with the connecting device so that the clamping-in-place occurs when putting the shell elements together.

A rigid, tensile strain-resistant arrangement is assisted because the connecting unit is fixed in place on the base heating element by fixing the associated connecting cable end and/or at least one cord end in place.

### BRIEF DESCRIPTION OF THE DRAWINGS

This invention is explained in greater detail in view of exemplary embodiments and making reference to the attached drawings, wherein:

FIG. 1 shows a supple heating device with a connecting unit between the heater cord and the connecting cable, in a schematic view;

FIG. 2 is a schematic view of a support plate of a connecting unit;

FIG. 3 is a schematic view showing an embodiment of a connecting section of a heater cord;

FIGS. 4A and 4B show two different embodiments of encapsulated connecting units in schematic views;

FIG. 5 is a perspective open plan view of one embodiment of a connecting unit;

FIG. 6 shows schematic views of various connecting means; and

FIGS. 7a-7c show different enlarged views of connecting devices, each in a cross section.

### DESCRIPTION OF PREFERRED EMBODIMENTS

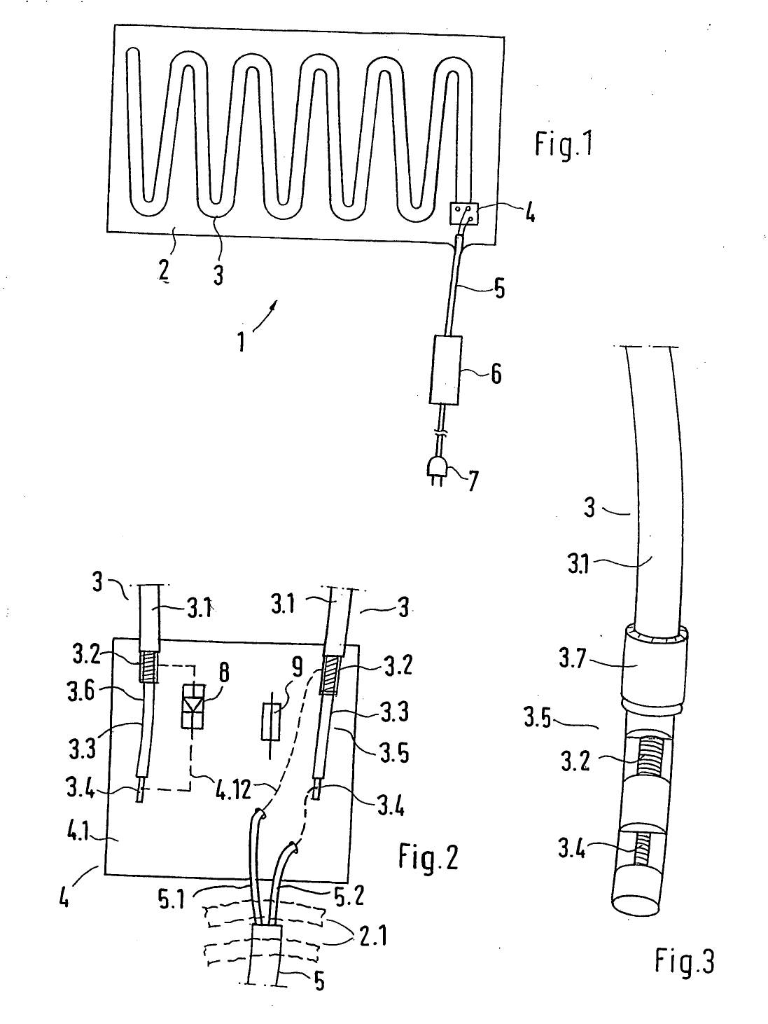

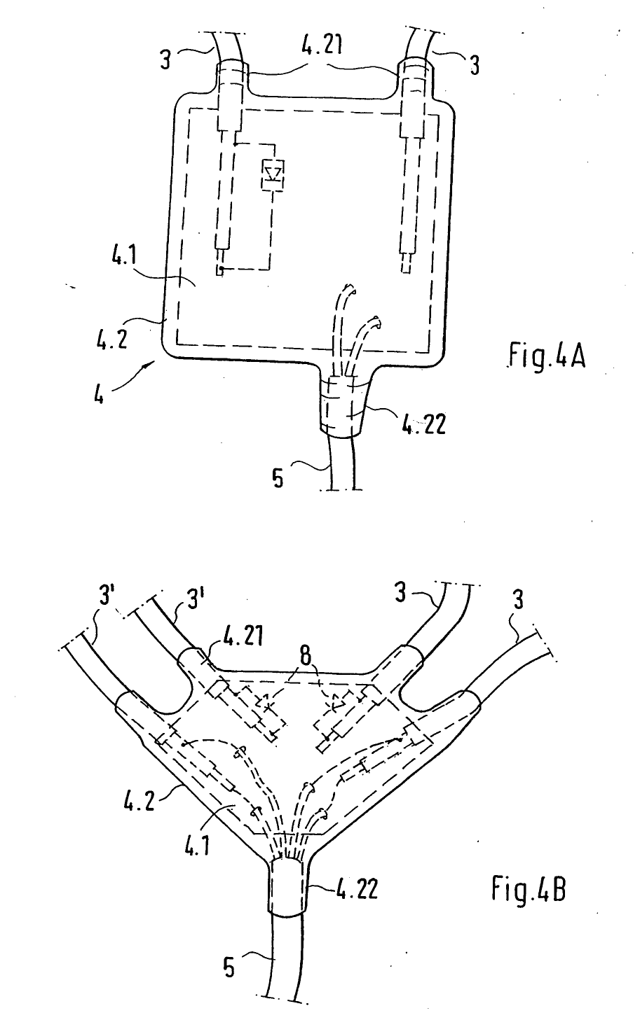

A supple heating device 1 with a heater cord 3, which is inserted in a meander shape in a supple base element 2, for example a blanket, a pad or a mattress pad, with a connecting cable 5, which can be connected to a supply voltage by a plug 7, and having a length arranged control circuit 6 and a connecting unit 4 arranged between the heater cord 3 and the connecting cable 5 in an edge area of the base element 2, is schematically represented in FIG. 1. As shown in FIG. 4B, different heating zones can be established on the base element 2 by at least one further heater cord 3′, which is placed on the base element 2.

As customary, the heater cord 3, 3′ advantageously has two heating conductors made of electric resistance wire, which are arranged, insulated from each other, in the heater cord 3, 3′, as shown in FIG. 2, for example. An advantageous, known per se, embodiment has one heating wire as the outer conductor 3.2, and the other heating wire as the inner conductor 3.4 extending in the heater cord 3, 3′ coaxially in relation to each other, are electrically insulated from each other by an intermediate insulation 3.3, are insulated toward the exterior by an outer insulation 3.1 and are wound in a coil shape. During current flow through the two heating conductors 3.2, 3.4 in opposite directions, a compensation of their electromagnetic fields is achieved. The inner conductor 3.4 is wound on an insulating core. As a so-called lan stranded conductor, it can also have several strands and is then particularly flexible and interruption-resistant.

As FIG. 2 shows, the cord end 3.5 at the side of the connecting cable and the cord end 3.6 facing away from it are both electrically wired and mechanically fixed in place on a support plate 4.1 of the connecting unit 4, wherein connections to the inner conductor 3.4 and the outer conductor 3.2 are also provided. Direct contact can be provided between the outer conductor 3.2 and the inner conductor 3.4, particularly at the cord end 3.6 remote from the connecting cable 5 or, as shown in FIG. 2, a rectifier arrangement in the form of one or several semiconductor diodes 8 can be provided. Also, other or additional electrical components can be connected between the outer conductor 3.2 and the inner conductor 3.4 on the support plate 4.1, such as shown in the two publications mentioned above, for example.

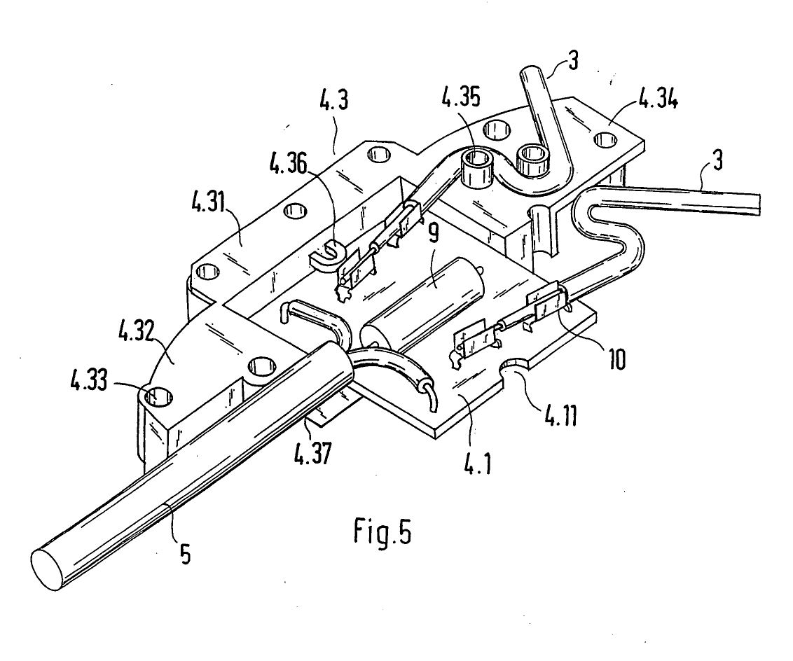

The cord end 3.5 at the side of the connecting cable is connected with the outer conductor 3.2 and the inner conductor 3.4 at associated leads 5.1, 5.2 of the connecting cable. A fuse element 9, for example a current fuse, can be arranged on the support plate 4.1 between one lead, for example 5.1, and a heating conductor, for example the outer conductor 3.2. The connection between the leads 5.1, 5.2 of the connecting cable 5 and the outer conductor 3.2 and the inner conductor 3.4 is provided by strip conductors 4.12 located on the side of the support plate 4.1 remote from the component side. In this case it is possible to use wire nails, holding lugs, supporting vanes or crimp connectors or the like as a connecting device or connecting means 10, as shown in FIGS. 5, 6 and 7, for providing an electrical connection between the outer conductor 3.2 and the inner conductor 3.4 on one side of the support plate 4.1, and they can be connected with the strip connectors 4.12 on the opposite side of the support plate 4.1. The components 8, 9, as well as the contact of the leads 5.1, 5.2 of the connecting cable 5 with the outer connector 3.2, or inner connector 3.4 can be correspondingly provided, which is known per se for a printed circuit board assembly. Clamping, crimping, soldering or welding connections can be used for contacting. The connecting cable 5 is connected with the base element 2, protected against tensile strain, by fixing devices 2.1, for example sewn or welded to it, in order to prevent the connecting cable 5 or the connecting unit 4 from being torn off. The heater cords 3, 3′ can be fastened on the base element 2, and the connecting unit 4 can be fixed in place on the base element 2. In one embodiment the mechanical connection between the base element 2 and the connecting unit 4 is in the form of a clip.

The clip has several functions, it can be used for tensile strain relief of the connecting cable 5, as fixation in place of the connecting unit 4, and therefore also as tensile strain relief of each heater cord 3, 3′, as a kinking protection of the connecting cable 5 in different embodiments, for example as a trumpet-shaped outlet opening, cable bushing, or the like, as a cover of the cable exit from the base element 2, or as a support for user information, logos, technical data, identification plates, or the like. The clip can be made of different materials, for example plastic, metal or a combination thereof. In one embodiment of the clip, snap-in hooks are provided, which are simultaneously used as penetrating tools through at least one cover layer of the base element 2 and can also provide a locking connection of the connecting unit 4. For a savings in tool expense, the clip is for example constructed so that self-locking can take place by two identical parts which are rotated by 180° with respect to each other. Alternatively the clip can be of one or several parts containing, for example, a sort of film hinge, which permits kinking.

The rectifier elements 8, and further possible electrical components, can work together with further electrical circuit components of the control circuit 6 for forming a temperature-regulating circuit and/or a safety system, for example as described in the publications previously mentioned.

FIG. 3 shows one embodiment of a connecting section of the heater cord 3, 3′. In this case a coupling element 3.7 is placed on the heater cord end 3.5, 3.6, for example by some type of screw connection or clamping, which has windows cut out over half its side, one of which exposes the outer connector 3.2 by omitting the outer insulation 3.1, and the other exposes the inner conductor 3.4 by omitting the outer insulation 3.1 of the outer connector 3.2 and the intermediate insulation 3.3. It is possible with the coupling element 3.7 to make an electrical contact as a coaxial plug with a complementarily embodied counter-element. The coupling element 3.7 can be contained in a connecting unit 4, such as an encapsulating element 4.3 of the latter, such as represented in FIGS. 4A, 4B and 5. In one embodiment of such a connection, wherein the coupling element 3.7, or the plug element of the heater cord 3 is pushed once into the counter-element of the connecting element and is snapped into, is no longer releasable, or wherein the connecting cable 5, which has one or several corresponding counter-elements, can be removed, for example for washing the heating device in a washing machine. In one embodiment, one side of the plug element has a one-sided short circuit of the heater cord 3 between the inner conductor 3.4 and the outer conductor 3.2. The connecting element then functions as a tensile strain relief of the heater cord 3, 3′.

The encapsulation represented in FIGS. 4A and 4B is produced by casting technology, wherein a heat-resistant, tensile strain-resistant and fire-resistant, hard-to-ignite insulating medium, which advantageously is also washable and water-tight, is completely cast around the support plate 4.1 with the assembled parts arranged thereon, such as structural components, connecting cable end and cord ends 3.5, 3.6. The melting resistance advantageously lies at least at 150° C., advantageously above 160° C. or 170° C., so that it assuredly resists occurring temperatures. A permanent melting resistance above 100° C. is assured. If, in spite of dependable contacting steps, contact resistance should occur and lead to heating, danger is prevented by the encapsulating element 4.2. Sealing cord guides 4.21, or a cable guide 4.22, for the cord ends 3.5, 3.6 and the connecting cable 5, which provide assured kinking protection for the heater cord 3, 3′ or the connecting cable 5, is formed in one piece on the encapsulating element 4.2, which is preferably made of an elastic insulation medium.

A connecting unit 4 for a heating device 1 with two heater cords 3, 3′ is represented in FIG. 4B, wherein the connectors as shown in FIG. 2 can be twice provided. It is also possible to select different ways of the connection of the two heater cords 3, 3′, such as described in connection with FIG. 2. For example, it would be conceivable to operate one heater cord with a temperature-control circuit with safety systems, such as in the prior art mentioned above, or respective further developments known per se, and the other heater cord with a simpler triggering circuit. In every case the connecting unit 4 permits a safe, definite connection of the heater cords 3, 3′ with the connecting cable 5, if desired via structural components used in connection with this arrangement.

FIG. 5 shows a further exemplary embodiment of a connecting unit 4. In this case the encapsulating element 4.3 is put together from two shell elements which can be brought into tight connection with each other, namely a lower element 4.31 and a cover element 4.38 (see FIG. 7), which have securing elements 4.33, for example in the form of blind bore openings, and cooperating counter-securing elements in the form of matched protrusions. Clamping or snap-in connections, or sealing, adhesive or welded connections are also suitable. The structure can also advantageously have a two-component plastic material with a harder core section and a more pliable, sealing cover. A center section of the encapsulating element 4.3 receives the support plate 4.1, while a cord guide device 4.34 formed on the center section with tensile strain relievers 4.35 is used for routing in the heating cords 3, 3′, and a cable guide device 4.32 formed on the center section for securely bringing in the connecting cable 5. For the definite positioning of the support plate 4.1 it has lateral positioning elements 4.11 in the form of recesses, which are engaged by matching counter-positioning elements 4.36 arranged on the center section of the encapsulating element 4.3. For obtaining tensile strain relief and sealing, the cable guide device 4.32 has a clamping element 4.37 for the connecting cable 5. Furthermore, clamping and contacting connecting means 10 are provided on the support plate 4.1 for the cord ends 3.5, 3.6, or their outer conductor 3.2 and inner conductor 3.4. A fuse element 9 and/or a rectifier device 8 in accordance with the previous embodiments as described can be arranged on the support plate 4.1.

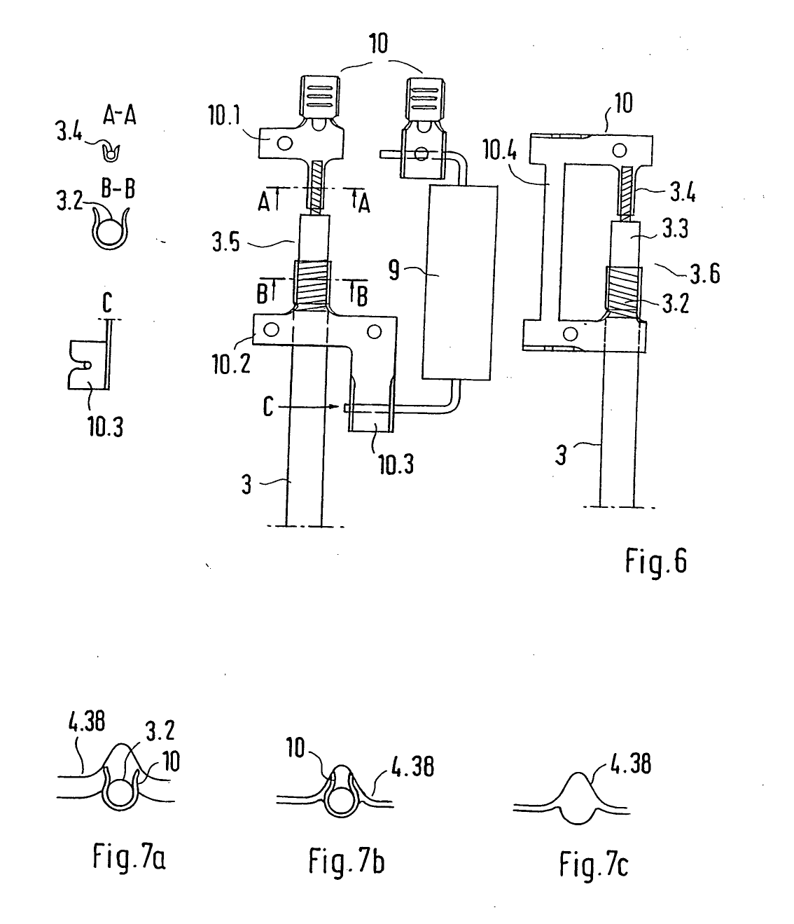

FIGS. 6 and 7 show various examples for the design of the connecting means 10 and their contacting arrangements. In accordance with FIG. 6, stamped-out and bent sheet metal elements are brought into contact with the inner conductor 3.4 of the heater cords 3, 3′ as the first connecting element 10.1, on the outer conductor 3.2 as the second connecting element 10.2, and as a further connecting element 10.3 with a structural component, for example the fuse element 9 or the semiconductor device in the form of a diode 8, wherein the second connecting element 10.2 and the further connecting element 10.3 are arranged on the same sheet metal element. For producing a direct connection, or a short circuit, between the inner conductor 3.4 and the outer conductor 3.2 at one cord end 3.6, the first connecting element 10.1 and the second connecting element 10.2 can be connected with each other via a conducting bridge 10.4. As the two sectional views A-A and B-B, as well as the view C in the left representation in FIG. 6 show, the outer conductor 3.2 and the inner conductor 3.4 are first inserted into an open clamping connector, which thereafter is bent shut, while the connectors of the structural elements 8 or 9 are clamped in a type of intersecting connection on the further connecting element 10.3.

As the figure sequence of FIGS. 7a and 7b shows, the clamping connection can be produced so that, for example, the cover element 4.38 of the encapsulating element 4.3 has recesses, which act together with the free ends of the connecting elements 10.1, 10.2, and become narrower, and whose flanks press the free ends of the connecting elements 10.1, 10.2 together when pushing on the cover element 4.38. FIG. 7a shows the still open, and FIG. 7b shows the pressed-on state of the cover element 4.38, while FIG. 7c shows the pressed-on state without a connecting means 10 inserted. In this case the connecting means 10 can be inserted into the encapsulating element 4.3 seated on a support plate 4.1, or directly without one.

Soldering and welding connections in general make lesser demands on the constructive solutions for the contact connections. In the simplest case, all components of the connecting unit can be soldered on a plate or on metallic conducting elements or welded. For example, the crimping devices of the heater cord contacting can be omitted, and for fastening the electric resistance wires it is only necessary to provide soldering pins in various embodiments for being wound-on and soldered. For example, the soldering pins or nails in a rectangular or other form can be pre-mounted on a board or in the plastic material. One advantage of rectangular soldering pins over round soldering pins is that the electrical resistance wire digs into the sharp corners and is less likely to slip, until the connection is soldered.

The connecting unit 4 can also be designed for receiving further or different components, for example, it can contain circuit elements of a safety device, such as described in detail in German Patent Reference DE 102 11 142 A1, for example further diodes, temperature safety devices, resistor elements triggering the latter in case of heat, temperature-regulating elements, time function elements, temperature-monitoring elements, or a switching unit, or combinations of such elements.

1. A supple heating device (1), including one of a heating blanket, a heating pad and a heated mattress pad, having at least one heater cord (3, 3′) arranged on a base heating element (2), a connected connecting cable (5) for energy supply via a connecting device (10) which are insulated toward an outside, and a control circuit (6), the supple heating device comprising:
the connecting device (10) combined into a connecting unit (4) having at least one of a common support plate (4.1) and a common encapsulating element (4.3).

2. The device in accordance with claim 1, wherein the connecting unit (4) is arranged on the base heating element (2) and is fixed in place by a holding device (2.1).

3. The device in accordance with claim 2, wherein the support plate (4.1) is a board with printed strip conductors and supports several connecting elements (10.1, 10.2, 10.3) of the connecting device (10), which are one of connected with an associated heating conductor (3.2, 3.4) and connected with an associated lead (5.1, 5.2) of the connecting cable (5) and are connectible with each other by strip conductors (4.12) for creating respective current paths.

4. The device in accordance with claim 3, wherein the at least one heater cord (3, 3′) has two heating conductors (3.2, 3.4) connected at one cord end (3.5) with associated leads (5.1, 5.2) of the connecting cable (5) and at an other cord end (3.6) are electrically connected with each other one of directly and via a rectifier arrangement (8) contained in the connecting unit (4).

5. The device in accordance with claim 4, wherein a current safety fuse (9) included in the connecting unit is arranged in a supply current circuit.

6. The device in accordance with claim 5 wherein the encapsulation element (4.3) is provided by encasing or by two assembled shell elements (4.31, 4.38).

7. The device in accordance with claim 6, wherein that the encapsulating element (4.3) has at least one cord guidance device (4.21) formed on for the heater cords (3, 3′), and a cable guidance device (4.22) for the formed on connecting cable (5).

8. The device in accordance with claim 7, wherein the encapsulating element (4.3) is of an elastic plastic material, at least near at least one of the cord guidance device (4.21) and the cable guidance device (4.22), is melt-resistant to at least 150° C, is flame-resistant and is resistant to tensile strain.

9. The device in accordance with claim 8, wherein the connecting device (10) is for inserting and clamping in place with electrical contact at least one of the heater cord ends (3.5, 3.6), and on a side facing the connecting device (10) a cover element (4.38) has formed-out places which work together with the connecting device (10) so that clamping in place occurs while putting the shell elements (4.31, 4.38) together.

10. The device in accordance with one claim 9, wherein the connecting unit (4) is fixed in place on the base heating element (2) by fixing in place at least one of the associated connecting cable end and at least one cord end (3.5, 3.6).

11. The device in accordance with claim 1, wherein the support plate (4.1) is a board with printed strip conductors and supports several connecting elements (10.1, 10.2, 10.3) of the connecting device (10) which are one of connected with an associated heating conductor (3.2, 3.4) and connected with an associated lead (5.1, 5.2) of the connecting cable (5) and are connectible with each other by strip conductors (4.12) for creating respective current paths.

12. The device in accordance with claim 1, wherein the at least one heater cord (3, 3′) has two heating conductors (3.2, 3.4) connected at one cord end (3.5) with associated leads (5.1, 5.2) of the connecting cable (5) and at an other cord end (3.6) are electrically connected with each other one of directly and via a rectifier arrangement (8) contained in the connecting unit (4).

13. The device in accordance with claim 1, wherein a current safety fuse (9) included in the connecting unit is arranged in a supply current circuit.

14. The device in accordance with claim 1, wherein the encapsulation element (4.3) is provided by encasing or by two assembled shell elements (4.31, 4.38).

15. The device in accordance with claim 14, wherein the encapsulating element (4.3) has at least one cord guidance device (4.21) formed on for the heater cords (3, 3′), and a cable guidance device (4.22) for the formed on connecting cable (5).

16. The device in accordance with claim 1, wherein the encapsulating element (4.3) is of an elastic plastic material, at least near at least one of the cord guidance device (4.21) and the cable guidance device (4.22), is melt-resistant to at least 150° C., is flame-resistant and is resistant to tensile strain.

17. The device in accordance with claim 6, wherein the connecting device (10) is for inserting and clamping in place with electrical contact at least one of the heater cord ends (3.5, 3.6), and on a side facing the connecting device (10) a cover element (4.38) has formed-out places which work together with the connecting device (10) so that clamping in place occurs while putting the shell elements (4.31, 4.38) together.

18. The device in accordance with claim 1, wherein the connecting unit (4) is fixed in place on the base heating element (2) by fixing in place at least one of the associated connecting cable end and at least one cord end (3.5, 3.6).
